(19) United States
(12) Patent Application Publication
(10) Pub. No.: US 2009/0301579 A1
(43) Pub. Date: Dec. 10, 2009

(54) VACUUM PRESSURE SYSTEMS WITH VACUUM CHAMBER FULL-RANGE, CLOSED-LOOP PRESSURE CONTROL

(75) Inventors: Randy Wong, Carmichael, CA (US); Matthew Mandeville, JR., Sacramento, CA (US); Ken Harrison, Fair Oaks, CA (US)

Correspondence Address: Randy Wong;GNB Engineering, Suite 100, 3200 Dwight Rd., Elk Grove, CA, 95758, US

(73) Assignee: GNB Corporation, Elk Grove, CA (US)

(21) Appl. No.: 12/136,769

(22) Filed: Jun. 10, 2008

(51) Int. Cl. F16K 31/04; G05D 7/06; F16K 31/53

(52) U.S. Cl. 137/489; 137/565.13; 251/249.5

(57) ABSTRACT

A flow control apparatus for a pressure system includes a chamber, a pump for providing a flow from the chamber and a valve positioned between the chamber and the pump for providing regulation of the flow. The valve is continuously operable between a fully open and a fully closed position. A motor continuously operates the valve between the open and closed positions. The motor includes a position encoder including an encoder output. A sensor continuously monitors the flow and includes a sensor output. A system interface receives the encoder output and the sensor output. The system interface processes the position encoder output to determine position and velocity of the motor and using at least the sensor output, position and velocity produces control signals for the motor. A servo driver receives the control signals from the system interface and continuously controls the motor in a closed-loop manner to regulate the flow.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to vacuum pressure systems. More particularly, the invention relates to a system that utilizes full-range, closed-loop pressure control on a vacuum chamber.

### BACKGROUND OF THE INVENTION

Within vacuum process control industries there is a growing demand for better process or environment and pressure control with minimal effects from particles in the immediate environment. Since gas particles that comprise a system's atmosphere are constantly moving, the regulation of the channel through which the particles pass into the system can increase or reduce the number of particles within the system. If a vacuum pump begins simultaneously removing gas particles from the chamber, the resultant pressure drop can be used as a means of defining when a system meets design requirements of purity within the chamber.

The term “throttle” refers to controlling the flow of a fluid or material in a process. For industries working with vacuum pressures, throttling often becomes an important component for systems that require high-precision pressure control. Closed-loop control is a design of a system that can create an effective throttling process for vacuum control. In its definition, closed-loop control refers to any system that recycles its output as the input to its new cycle. By designing a throttling valve system with closed-loop control, an engineer can create a very efficient system with low-response times.

A throttling pendulum valve can provide the necessary throughput control to regulate the pressure within a chamber. These valves are often used within the vacuum industry because they offer reliable control with compact and durable design, extended life spans, and clean operation. A plate swings back and forth within the stream of flow to control the level of pressure within the chamber by regulating or preventing gas flow to and from the chamber. Many pendulum valves use pneumatic air cylinders to move the valve through different positions by driving a series of links that rotate the drive shaft of the valve. However, pneumatic cylinders require a constant air supply as well as electricity to operate, and pneumatic cylinders are limited to pre-defined positions, reducing their accuracy and response-time to changes in pressure.

Other pendulum valves have stepper motors that only need electricity to operate, resulting in a cleaner, simpler design; air supplies often require large and loud compressors and create more particulate within an environment. Stepper motors can offer greater accuracy and adjustment, as the end-user only needs to learn the electronic software interface to operate the valve while an air cylinder must be rebuilt according to the necessary changes. Stepper motors are limited in their response time and accuracy, however, because they can only rotate into a certain number of positions. Such motors also lose precision at higher speeds, which impedes a stepper motor's ability to adjust quickly to pressure changes if a specific pressure is to be maintained.

The precision of stepper motors leaves a desire for control that is not limited to a preset number of stops. In the context of pressure control for vacuum chambers, where a small change in pressure may eventually result in numerous faulty manufacturing processes, there is a need for the system to know exactly how to adjust to a change in pressure conditions. The preset steps keep a system from awareness to its current position and pressure, forcing the system to “guess” how much to adjust, which could be too much or too little. The stepper motor may over compensate and then spend extra time readjusting to the error of the previous step.

Throughout the valve industry, many industrial designs have gearboxes that function as actuators. When designing a gearbox, backlash is an important design concern that refers to the shifts in position of a system's internal parts due to the clearances between parts. Gear-sets often experience significant amounts of torque, which may cause the gears to shift in a manner that may be detrimental to the ability of the gears to transmit the most drive to the system. Gear-sets also may experience shifts during transport, which then require the end user to make corrective adjustments. In order to maintain accuracy and prolong the life of a gear set, a system should allow for some maintenance to minimize backlashing.

In view of the foregoing, there is a need for improved techniques for providing a pressure control system that provides enhanced accuracy and adjustment, is able to respond quickly to pressure changes and allows for maintenance to minimize backlashing.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1 through 5 illustrate an exemplary closed-loop control throttling pendulum valve system, in accordance with an embodiment of the present invention.

FIG. 1 is a perspective view of the system.

FIG. 2 is a top cut-away view revealing the internal components of a gearbox.

FIG. 3 is a side cut-away view of the gearbox.

FIG. 4 is a cross sectional view of the assembly of a drive shaft.

FIG. 5 is a perspective view of the internal components of the gearbox and the drive shaft.

Unless otherwise indicated illustrations in the figures are not necessarily drawn to scale.

### SUMMARY OF THE INVENTION

To achieve the forgoing and other objects and in accordance with the purpose of the invention, a vacuum pressure system with vacuum chamber full-range, closed-loop pressure control is presented.

In one embodiment, a flow control apparatus for a pressure system is presented. The apparatus includes a chamber, a pump for providing a flow from the chamber and a valve positioned between the chamber and the pump for providing regulation of the flow. The valve is continuously operable between a fully open and a fully closed position. A motor continuously operates the valve between the fully open and fully closed positions. The motor includes a position encoder including an encoder output. A sensor continuously monitors the flow. The sensor includes a sensor output. A system interface receives the encoder output and the sensor output. The system interface processes the position encoder output to determine position and velocity of the motor and using at least the sensor output, position and velocity produces control signals for the motor. A servo driver computer receives the control signals from the system interface and continuously controls the motor in a closed-loop manner to regulate the flow. Another embodiment further includes a gearbox including a gear-set for translating torque from the motor to the valve. In another embodiment the gear-set includes a worm gear-set and the gearbox further includes an adjustment means for adjusting a mating surface between a worm and a gear in the worm gear-set to mitigate a mechanical hysteresis caused by backlash. In other embodiments, the system interface further includes visual user-interface means for displaying system status and user-input means for influencing actions and characteristics of the pressure system. In still another embodiment the system interface processes information from multiple closed-loop systems. In yet another embodiment, the system interface further includes means for supplying power and encoding of signals to the motor. Another embodiment further includes additional sensors for continuously monitoring flows at different locations in the pressure system and providing additional sensor outputs for input to the system interface to produce the control signal. In still another embodiment, the chamber includes a vacuum chamber, the pump includes a vacuum pump and the sensor measures pressure.

In another embodiment an apparatus for controlling a vacuum pressure in a vacuum pressure system is presented. The apparatus includes a vacuum chamber and a vacuum pump operative for providing the vacuum pressure in the vacuum pressure system. A valve is positioned between the vacuum chamber and the vacuum pump for providing regulation of the vacuum pressure. The valve is continuously operable between a fully open and a fully closed position. A servomotor continuously operates the valve between the fully open and fully closed positions. The servomotor includes a position encoder including an encoder output. A vacuum pressure measurement unit continuously monitors the vacuum pressure and includes a vacuum pressure output. A system interface receives the encoder output and the vacuum pressure output. The system interface processes the position encoder output to determine position and velocity of the motor and using at least the vacuum pressure output, position and velocity to produces control signals for the servomotor. A servo driver computer receives the control signals from the system interface and continuously controls the servomotor in a closed-loop manner to regulate the vacuum pressure. Another embodiment further includes a gearbox including a gear-set for translating torque from the servomotor to the valve. In another embodiment the gear-set further translates motion from the servomotor at a right angle. In yet another embodiment the gear-set includes a worm gear-set and the gearbox further includes an adjustment means for adjusting a mating surface between a worm and a gear in the worm gear-set to mitigate a mechanical hysteresis caused by backlash. In other embodiments the system interface further includes visual user-interface means for displaying system status and user-input means for influencing actions and characteristics of the system. In still another embodiment the system interface processes information from multiple closed-loop systems. In yet another embodiment the system interface further includes means for supplying power and encoding of signals to the servomotor. Yet another embodiment further includes additional vacuum pressure measurement units for continuously monitoring vacuum pressures at different locations in the system and providing additional vacuum pressure outputs for input to the system interface to produce the control signal.

In another embodiment an apparatus for controlling a flow in a pressure system is presented. The apparatus includes a chamber, means for providing the flow in the pressure system, means for providing regulation of the flow, means for continuously operating the regulation means, means for continuously monitoring the flow, means for producing control signals for the means for continuously operating the regulation means and means for receiving the control signals and continuously controlling the means for continuously operating the regulation means in a closed-loop manner to regulate the flow. Another embodiment further includes means for translating motion from the means for continuously operating the regulation means and the regulation means.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

A preferred embodiment of the present invention provides full-range, closed-loop feedback servomotor control to a throttling valve that is installed in a vacuum pressure system. Since the preferred embodiment only needs electricity to operate, the requirement of an air supply from prior-art pneumatic systems is eliminated, creating a cleaner operation. By full-range, it is meant that the valve is able to be positioned at and anywhere in between open and closed positions. The more positions possible for a throttling valve, the more accurate and shorter the response time of the valve will be to respond to changes in pressure. This presents an improvement to the limited accuracy and response times of currently known stepper motor designs.

A desired characteristic of preferred embodiments of the present invention is to use a gear-set to reduce the amount of input torque necessary to operate the valve. This enables the design to use a smaller servomotor, reducing cost and size. For a preferred embodiment, a worm gear-set is used; however, alternate embodiments may use various other types of gear-sets. Another desired characteristic of preferred embodiments is to minimize rotational backlash within the system. This is accomplished in a preferred embodiment by driving a worm gear-set using a mating tapered shaft and hub design. Another desired characteristic of preferred embodiments is to enable the end-user to adjust the gear-set position and positional stop switches to fit specific needs, such as, but not limited to, gradual shifting from daily operation. This enables the system to maintain optimal efficiency and accuracy over time.

Another desired characteristic of preferred embodiments is the use of closed-loop feedback control to determine the behavior of the system. Closed-loop feedback control refers to a system that uses its output for the input to its next cycle of operation. Within the scope of preferred embodiments of the present invention, the system is designed to receive pressure readings from a vacuum chamber and operate the valve in a manner that brings the system closer to the desired vacuum pressure for the system. Errors within the system, for example, without limitation, from valve position to chamber parameters, can be compensated within a closed-loop system because the system not only detects the effects of the discrepancy but also adjusts the valve position to accommodate for such changes. Since the servomotor's movement is dynamically controlled by the closed-loop feedback in preferred embodiments, the servomotor is not as limited in accuracy as a stepper motor, which can overcompensate because a stepper motor can only move within a preset number of positions.

The use of servomotors in preferred embodiments of the present invention provide the system with a position encoder within the servomotor, which provides a closed-loop position control and a velocity feedback loop. This facilitates highly accurate, rapid positioning with essentially no overshooting. Overshooting refers to the motor moving too far beyond its target position and having to backtrack to correct its position. A servomotor moves to its position using the closed-loop feedback data, meaning the servomotor constantly knows how much farther it needs to go and how fast it should be going as it nears its destination.

An additional desired characteristic of preferred embodiments of the present invention is the implementation of an electronic control interface that displays system parameters, such as, but not limited to, pressure and valve position and enables user-control of the system operation. A preferred embodiment uses an interface that can operate the servomotor under several different modes. The servomotor in this embodiment can be operated under a simple position control in which the user controls how the valve cycles through customizable positions. The interface in this embodiment can also run under a pressure control mode in which the pressure feedback can be compared with a variety of target pressures to determine how far and quickly to rotate the valve to adjust to pressure changes. For example, without limitation, if the pressure suddenly changes dramatically, the interface in this embodiment can rotate the valve quickly and then slow down the rotation of the valve as the system nears the target pressure. This mode of operation is an important function of the electronic control interface because it is a link in the closed-loop feedback control design.

Such characteristics of preferred embodiments of the present invention can be valuable to anyone who works with vacuum pressures and chambers. For example, without limitation, physical thin-film deposition manufacturing processes are often used to make semiconductors and aluminum-coated PET film for snack bags. By submitting a specific material to vacuum pressure, a target product can collect the material's atoms as the pressure conditions cause the atoms to break free from their bonds. The vacuum pressure conditions within the chamber enable the atoms of the gas to reach the substrate of the material without interference from undesired atoms in the chamber atmosphere. Any impurities can form deposits on the substrate as well, reducing the quality of the deposition process; it is important that as many impurities as possible are removed from the chamber before the process begins. Maintaining a high quality vacuum can be essential to companies working in related fields if minimizing manufacturing errors and maximizing efficiency is a priority.

A basic embodiment of the present invention comprises a valve that regulates pressure levels in a vacuum chamber. This valve can be any vacuum sealing valve such as, but not limited to, a pendulum, gate, or butterfly valve. The valve is actuated by a gear-set housed within a gearbox. This gear-set can be any combination of gear set(s) that can deliver enough torque to operate the valve within all of the required ranges of operation, such as, but not limited to, worm, bevel, or planetary gearing. In some embodiments the gear-set may translate rotary motion at a right angle, allowing for a more compact design.

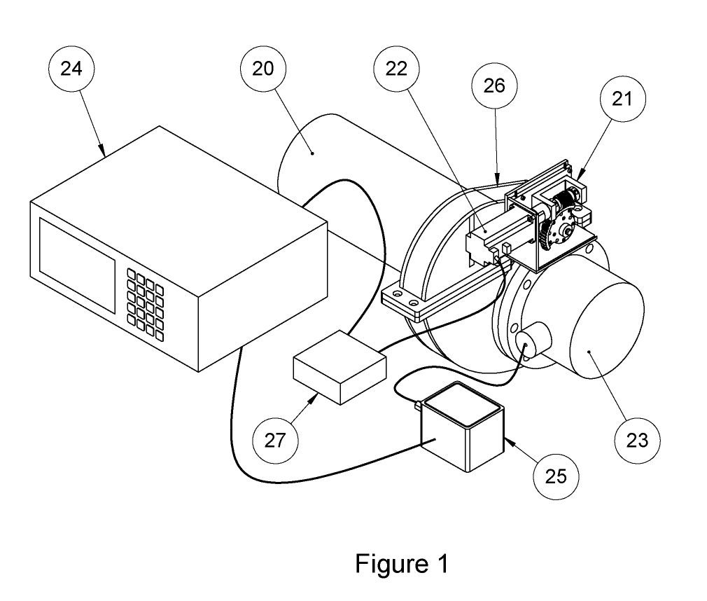

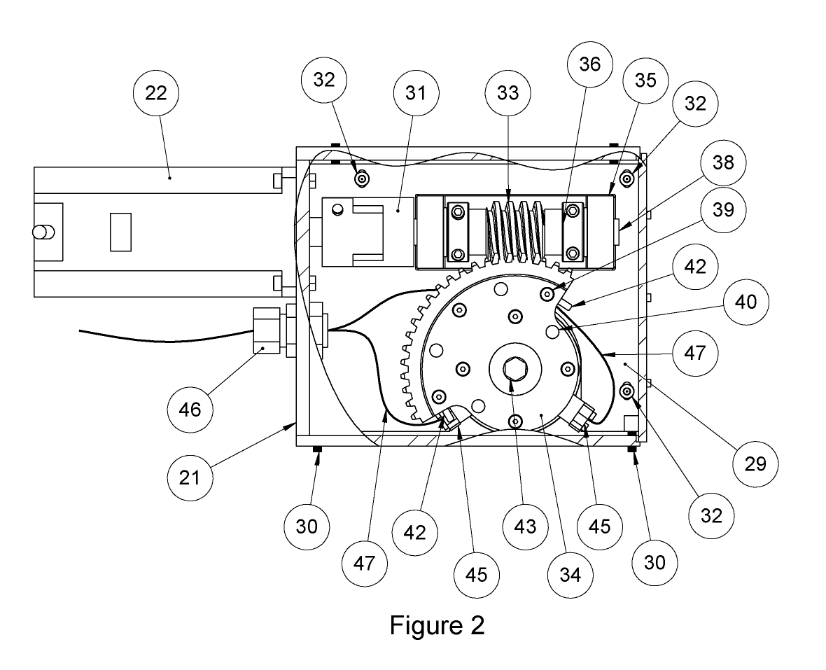

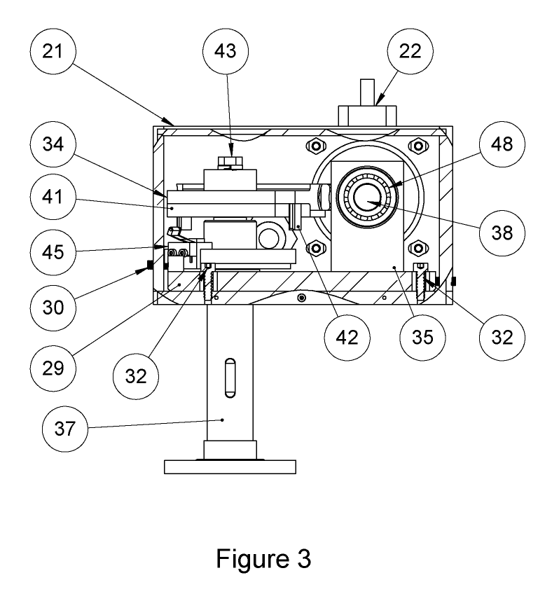

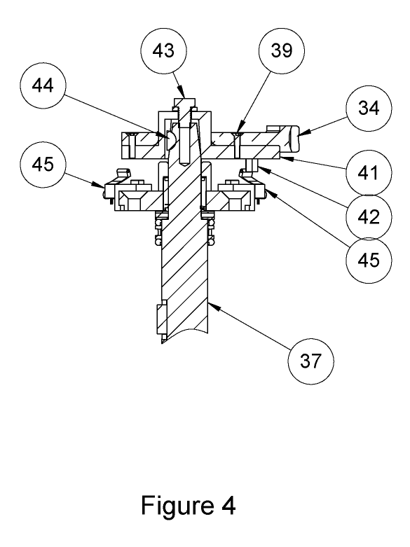

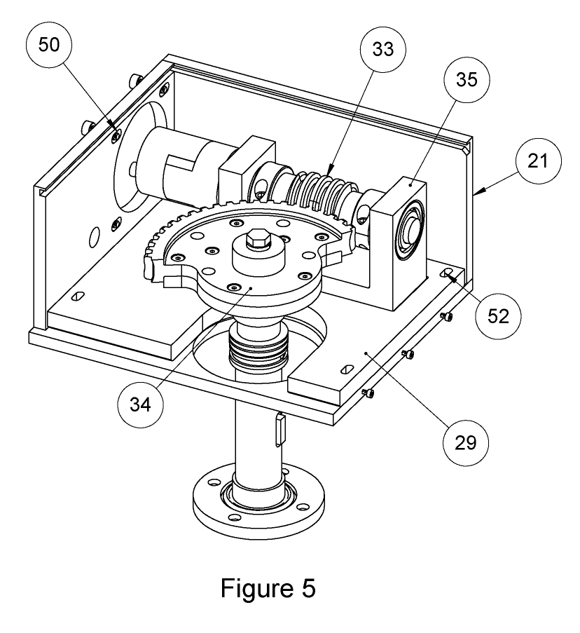

FIGS. 1 through 5 illustrate an exemplary closed-loop control throttling pendulum valve system, in accordance with an embodiment of the present invention. FIG. 1 is a perspective view of the system. FIG. 2 is a top cut-away view revealing the internal components of a gearbox 21. FIG. 3 is a side cut-away view of gearbox 21. FIG. 4 is a cross sectional view of the assembly of a drive shaft 37. FIG. 5 is a perspective view of the internal components of gearbox 21 and drive shaft 37.

Referring to FIG. 1, in the present embodiment, a valve 26 is located between a vacuum pump 20 and a vacuum chamber 23. Valve 26 regulates the pressure within vacuum chamber 23 as pump 20 works to maintain a certain vacuum pressure condition. In order to do so, valve 26 is rotated to positions between and including open and closed positions by a mounted gearbox 21. In the present embodiment valve 26 is a pendulum valve; however, alternate embodiments may use various other types of valves such as, but not limited to, gate valves, butterfly valves, angle valves, flapper valves, and pendulum valves. Gearbox 21 is driven by a servomotor 22, which sends position feedback to and receives power from a servo driver computer 27. Servo driver computer 27 interprets signals from servomotor 22 and sends these signals to an electronic system interface 24, which presents the information to a user. Electronic system interface 24 also sends instructions to servo driver computer 27, which is then relayed to servomotor 22. These instructions are dependent on user-input from system interface 24 and the feedback from a pressure measurement system 25, which monitors the vacuum pressure in vacuum chamber 23.

The present embodiment uses a servo-driven, closed-loop pressure measurement design to provide accurate servomotor response to pressure changes within the system. This servo control system comprises a minimum of three feedback loops, pressure, position and speed, for a faster and more accurate method of controlling servomotor 22. Electronic system interface 24 may be any piece of equipment that receives, processes, and sends feedback signals from and to vacuum pressure measurement unit 25 and servomotor 22. In various embodiments, electronic system interface 24 may provide other features including, but not limited to, a visual user-interface that provides a means of displaying system status and enables user-input that influences the actions and characteristics of the system, for example, without limitation, adjusting the desired vacuum pressure level or speed of servomotor 22. In other embodiments the electronic system interface may not enable user interaction and may instead function in accordance with the feedback that is received from the feedback loops. During basic functioning of the present embodiment, electronic system interface 24 serves as the center of control to the system from which instructions for all of the other aspects of the present embodiment are transmitted including, but not limited to, feedback instructions to servomotor 22. Closed-loop control is completed by feedback that electronic system interface 24 receives from vacuum pressure measurement unit 25 that monitors the vacuum pressure levels within vacuum chamber 23 and reports to electronic system interface 24. The measurement can be made by any means that effectively measures vacuum pressure levels, such as, but not limited to, a capacitance manometer, thermo coupler, or ionization gauge, Bayard-Alpert gauge, etc. Such a closed-loop system enables the present embodiment to provide dynamic response to the condition of the vacuum within monitored vacuum chamber 23.

In the present embodiment, valve 26 is actuated by a gear-set comprising a worm gear 34 and a mating worm 33. However, in alternate embodiments, the valve may be actuated by various other types of gear-sets such as, but not limited to, bevel, spur, planetary gearing or a belt drive. Combinations of gear-sets may also be used in some embodiments. The gear-set in the present embodiment translates motion at a right angle; however, alternate embodiments may implement an in-line design. Referring to FIGS. 2 and 3, gearbox 21 houses the worm gear-set, providing protection from external objects. Gearbox 21 comprises a box with a secondary bottom plate 29 that is shorter than the width of the box, allowing room for secondary bottom plate 29 to slide closer to or away from worm gear 34. This allows for adjustment for backlashing of worm gear 34 and worm 33. Secondary bottom plate 29 is set by two sets of four screws 30 and 32, securing secondary bottom plate 29 in place. The first set of screws 30 prevents any further horizontal movement and the second set of screws 32 holds secondary bottom plate 29 to the bottom of gearbox 21.

Worm 33 is installed on an input shaft 38 that is secured by a shaft coupler assembly 31 to servomotor 22. When servomotor 22 rotates its shaft, input shaft 38, drives worm 33. Worm 33 is held in place by a mounting 35, ball bearings 48, and a series of shaft collars and spacers 36 that generally prevent the assembly from traveling axially due to backlashing. Worm 33 drives worm gear 34 when worm 33 rotates, transmitting torque that is magnified due to the worm gear ratio. Worm gear 34 then drives drive shaft 37, which is connected to and drives valve 26, rotating valve 26 between open and closed positions.

Worm gear 34 is fixed to a hub 41 through a series of fasteners 39 and 40. In the present embodiment fasteners 39 are screws and fasteners 40 are dowel pins. However, in alternate embodiments, the gear may be fixed to the hub using various different types of fastening methods such as, but not limited to, bolts, welding, adhesive, etc. In various embodiments, the worm gear may be made of any material that is strong enough to withstand the operating torque, such as, but not limited to, steel, plastic, brass, stainless steel, and aluminum, and in the present embodiment bronze is chosen for its self-lubricating characteristic. Referring to FIG. 4, there is a tapered bore through the center of hub 41 that mates to a tapered tip on the main drive shaft 37. Drive shaft 37 is tapered and coupled to the tapered bore of hub 41 by a fastener 43, for example, without limitation, a screw and lock washer, that provides an axial force that “pulls” drive shaft 37 into the bore of hub 41. The angles of the mating tapers help prevent backlashing between hub 41 and drive shaft 37 with a key 44 for additional support. Key 44 may be any type of key that effectively fits within the taper design, such as, but not limited to, woodruff, square, gib head, taper, parallel, and rectangular key design. Alternate embodiments may be implemented without a key. By way of example, and not limitation, one such embodiment a taper shaft that features a threaded tip that allows a nut to tighten the gear hub to the shaft. Another embodiment includes the shaft and hub featuring a mating spline design.

In the present embodiment, gearbox 21 also has a safety feature that generally prevents valve 26 from over-clocking past the open and closed positions as defined and controlled by electronic system interface 24. For whatever reason, if the software of electronic system interface 24 fails to stop servomotor 22 and the gate of valve 26 attempts to continue to rotate past its fully open and closed positions, worm gear 34 trips one of two switches 45 that stop servomotor 22. Switches 45 are located to correspond to positions just past the fully opened and closed positions of valve 26 and, when activated by a rotating switch lever 42, provide a signal to electronic system interface 24 to stop servomotor 22; the result is an “emergency stop” that assists in generally preventing excessive wear on valve 26 internals and over-exertion by servomotor 22. Wires 47 that connect switches 45 to electronic system interface 24 are protected by a cord-grip 46 that holds wires 47 together, preventing wires 47 from pulling or pushing from external forces. Alternate embodiments may be implemented without this safety feature.

In the present embodiment, input drive shaft 38 is driven by servomotor 22 that sends continuous position feedback through servo driver computer 27 to electronic system interface 24. In a basic form, electronic system interface 24 should at least be able to receive feedback signals from vacuum pressure measurement system 25 and send and receive signals to servo driver computer 27. Additional, but optional, features of electronic system interface 24 may include, without limitation, displaying system information, offering user controls, and supplying power to any of the system elements. Input drive shaft 38 is coupled to servomotor 22 through shaft coupler assembly 31. The continuous position feedback of servomotor 22 gives the system a constantly up-to-date awareness of the position of valve 26 and vacuum quality.

Referring to FIG. 5, in the present embodiment, some components of gearbox 21 are able to be manually adjusted by the user to eliminate the mechanical hysteresis that is caused by backlash. As a result of the control system's improved accuracy, the gear train must also increase in accuracy. In the present embodiment, worm 33 in reference to its mating worm gear 34 can be increased or decreased. Worm 33 is coupled by mounting 35 to secondary bottom plate 29 of gearbox 21, which features slotted mounting holes 52 that provide room for secondary bottom plate 29 to slide worm 33 closer to or farther from worm gear 34. Additionally, the side of gearbox 21 to which servomotor 22 mounts also features slotted mounting holes 50 that enable servomotor 22 to travel with worm 33 if any adjustments are made. This enables the user to provide easy routine maintenance and adjustments to optimize the performance of gearbox 21.

In an exemplary use of the present embodiment, a company using vacuum pressures to manufacture semiconductors may install pendulum valve 26 with gearbox 21 between vacuum chamber 23 and vacuum pump 20. Gearbox 21 is connected to electronic system interface 24, located in a control room, and servomotor 22 is connected to servo driver computer 27. Installing vacuum pressure measurement system 25, for example, without limitation, a capacitance monometer, on vacuum chamber 23 enables electronic system interface 24 to receive information pertaining to the pressure in vacuum chamber 23, for example, without limitation, signals that the pressure is within or outside of the desired range. Electronic system interface 24 transmits instructions to servo driver computer 27 to operate valve 26 in a way that maintains the pressure in vacuum chamber 23 until electronic system interface 24 receives feedback that the pressure is outside of the acceptable operating range. For example, without limitation, if electronic system interface 24 detects that the pressure within vacuum chamber 23 is above the desired range, electronic system interface 24 sends a signal to servo driver computer 27 to open valve 26, allowing vacuum pump 20 to drop the pressure back into range. Once electronic system interface 24 receives a signal from vacuum pressure measurement system 25 that the system is back within operating pressure, electronic interface system 24 sends another signal to servo driver computer 27 to operate valve 26 in a way that regulates the pressure in vacuum chamber 23. Valve 26 continues to operate in this manner as long as the pressure within vacuum chamber 23 remains within the acceptable operating pressure.

Various alternate embodiments may be implemented to provide different types of fluid control to a process. The valve in these embodiments is not limited to control a vacuum; for example, without limitation, the valve may regulate the flow of a liquid medium provided that the valve can operate under such environmental conditions. For example, without limitation, in embodiments that control a liquid, the valve may be any type of valve that can regulate the flow of the liquid, such as, but not limited to, a butterfly valve.

The gearbox is adjustable in the preferred embodiment described in reference to the Figures via slotted mounting holes. However, alternate embodiments may have various different designs that enable the user to manually adjust the mating surface between the gears in the gear-set. For example, without limitation, in one possible alternate embodiment, the worm itself is moveable, rather than a portion of the gearbox. Another alternate embodiment enables the gear-set to be raised or lowered with respect to the base plate of the gearbox.

In another alternate embodiment the gear-set may be eliminated. In this embodiment the servomotor is mounted directly to the drive shaft of the valve. This embodiment may require a larger servomotor to provide the needed torque to control the valve; however, this embodiment may be preferred when simplicity of design is paramount.

In another alternate embodiment of the present invention, the closed-loop system may be controlled by an electronic controller interface that handles the information from multiple closed-loop systems. Furthermore, the interface in some embodiments may also contain the software and capabilities to supply power and encoding to the servomotor, effectively eliminating the need for a separate servo driver unit.

In other alternate embodiments of the present invention, the vacuum pressure measurement unit may be of any design that effectively measures pressure at a specified spot in the system. The placement of the unit's readings is not limited to the vacuum chamber. For example, without limitation, the pressure measurement unit may be placed at the vacuum pump and read pressures upstream of the process. In some embodiments, there may be multiple pressure measurement units that provide feedback readings from different places along the process.

Having fully described at least one embodiment of the present invention, other equivalent or alternative methods of providing a full-range, closed-loop feedback servomotor control to a throttling valve according to the present invention will be apparent to those skilled in the art. The invention has been described above by way of illustration, and the specific embodiments disclosed are not intended to limit the invention to the particular forms disclosed. For example, the particular implementation of the electronic components may vary depending upon the particular type of system interface used. The electronic components described in the foregoing were directed to implementations where the electronic components were separate from each other; however, similar techniques are to integrate the electronic components such as, but not limited to, the servo driver computer and pressure measurement unit into the system interface. Implementations of the present invention with electronic components integrated into the system interface are contemplated as within the scope of the present invention. The invention is thus to cover all modifications, equivalents, and alternatives falling within the spirit and scope of the following claims.

What is claimed is:

1. A flow control apparatus for a pressure system, the apparatus comprising:
a chamber;
a pump for providing a flow from said chamber;
a valve positioned between said chamber and said pump for providing regulation of said flow, said valve continuously operable between a fully open and a fully closed position;
a motor for continuously operating said valve between said fully open and fully closed positions, said motor comprising a position encoder comprising an encoder output;
a sensor for continuously monitoring said flow, said sensor comprising a sensor output;
a system interface receiving said encoder output and said sensor output, said system interface processing said position encoder output to determine position and velocity of said motor and using at least said sensor output, position and velocity to produce control signals for said motor; and
a servo driver computer receiving said control signals from said system interface and continuously controlling said motor in a closed-loop manner to regulate said flow.

2. The flow control apparatus as recited in claim 1, further comprising a gearbox comprising a gear-set for translating torque from said motor to said valve.

3. The flow control apparatus as recited in claim 2, wherein said gear-set comprises a worm gear-set and said gearbox further comprises an adjustment means for adjusting a mating surface between a worm and a gear in said worm gear-set to mitigate a mechanical hysteresis caused by backlash.

4. The flow control apparatus as recited in claim 1, wherein said system interface further comprises visual user-interface means for displaying system status.

5. The flow control apparatus as recited in claim 4, wherein said system interface further comprises user-input means for influencing actions and characteristics of the pressure system.

6. The flow control apparatus as recited in claim 4, wherein said system interface processes information from multiple closed-loop systems.

7. The flow control apparatus as recited in claim 1, wherein said system interface further comprises means for supplying power and encoding of signals to said motor.

8. The flow control apparatus as recited in claim 1, further comprising additional sensors for continuously monitoring flows at different locations in the pressure system and providing additional sensor outputs for input to said system interface to produce said control signal.

9. The flow control apparatus as recited in claim 1, wherein said chamber comprises a vacuum chamber, said pump comprises a vacuum pump and said sensor measures pressure.

10. An apparatus for controlling a vacuum pressure in a vacuum pressure system, the apparatus comprising:
a vacuum chamber;
a vacuum pump operative for providing the vacuum pressure in the vacuum pressure system;
a valve positioned between said vacuum chamber and said vacuum pump for providing regulation of the vacuum pressure, said valve continuously operable between a fully open and a fully closed position;
a servomotor for continuously operating said valve between said fully open and fully closed positions, said servomotor comprising a position encoder comprising an encoder output;
a vacuum pressure measurement unit for continuously monitoring the vacuum pressure, said vacuum pressure measurement unit comprising a vacuum pressure output;
a system interface receiving said encoder output and said vacuum pressure output, said system interface processing said position encoder output to determine position and velocity of said motor and using at least said vacuum pressure output, position and velocity to produce control signals for said servomotor; and
a servo driver computer receiving said control signals from said system interface and continuously controlling said servomotor in a closed-loop manner to regulate the vacuum pressure.

11. The apparatus as recited in claim 10, further comprising a gearbox comprising a gear-set for translating torque from said servomotor to said valve.

12. The apparatus as recited in claim 11, wherein said gear-set further translates motion from said servomotor at a right angle.

13. The apparatus as recited in claim 11, wherein said gear-set comprises a worm gear-set and said gearbox further comprises an adjustment means for adjusting a mating surface between a worm and a gear in said worm gear-set to mitigate a mechanical hysteresis caused by backlash.

14. The apparatus as recited in claim 10, wherein said system interface further comprises visual user-interface means for displaying system status.

15. The apparatus as recited in claim 14, wherein said system interface further comprises user-input means for influencing actions and characteristics of the system.

16. The apparatus as recited in claim 14, wherein said system interface processes information from multiple closed-loop systems.

17. The apparatus as recited in claim 10, wherein said system interface further comprises means for supplying power and encoding of signals to said servomotor.

18. The apparatus as recited in claim 10, further comprising additional vacuum pressure measurement units for continuously monitoring vacuum pressures at different locations in the system and providing additional vacuum pressure outputs for input to said system interface to produce said control signal.

19. An apparatus for controlling a flow in a pressure system, the apparatus comprising:
a chamber;
means for providing the flow in the pressure system;
means for providing regulation of the flow;
means for continuously operating said regulation means;
means for continuously monitoring the flow;
means for producing control signals for said means for continuously operating said regulation means; and
means for receiving said control signals and continuously controlling said means for continuously operating said regulation means in a closed-loop manner to regulate the flow.

20. The apparatus as recited in claim 19, further comprising means for translating motion from said means for continuously operating said regulation means and said regulation means.
